(19) United States
(12) Patent Application Publication
(10) Pub. No.: US 2025/0210912 A1
(43) Pub. Date: Jun. 26, 2025

(54) CONNECTOR LOCKING MECHANISM AND CONNECTOR ASSEMBLY INCLUDING THIS CONNECTOR LOCKING MECHANISM

(71) Applicant: Japan Aviation Electronics Industry, Limited, Tokyo (JP)

(72) Inventor: Masashi TANAKA, Tokyo (JP)

(21) Appl. No.: 18/796,396

(22) Filed: Aug. 7, 2024

(30) Foreign Application Priority Data
Dec. 20, 2023 (JP) 2023-214877

(51) Int. Cl. H01R 13/627; H01R 13/633

(52) U.S. Cl. CPC H01R 13/6273; H01R 13/633

(57) ABSTRACT

A connector locking mechanism comprises a first connector includes including a cantilevered locking member extending in a first direction, and having a first locking shaped portion, and a first unlocking portion having an inclined surface and formed between a fixed end of the locking member and the first locking shaped portion; and a second connector including an unlocking member held to be movable in the first direction and the second direction, a second locking shaped portion to be engaged with the first locking shaped portion, and a second unlocking portion having an inclined surface to be brought into contact with the inclined surface of the first unlocking portion when the second connector is mated with or withdrawn from the first connector.

### CROSS-REFERENCE TO RELATED APPLICATION

This application is based on and claims priority to Japanese Patent Application No. 2023-214877 filed on Dec. 20, 2023, the entire disclosures of which are hereby incorporated by reference herein.

### BACKGROUND OF THE INVENTION

### Field of the Invention

The present invention relates to a connector locking mechanism and a connector assembly including this connector locking mechanism.

### Description of the Related Art

A connector locking mechanism for locking a mated state when a first connector and a second connector are mated in a connector assembly formed by mating the first connector and the second connector with each other is conventionally known. For example, the specification of U.S. Patent Application Publication No. 2015/0118886 discloses an electrical connector (100) including a connector locking mechanism for securely holding a mated state when a first connector (30) and a second connector (40) are mated as shown in FIGS. 28 and 29. This electrical connector (100) includes a cantilevered first locking member (3) extending backward in a direction of mating in the first connector (30), a locking portion (31) formed as an opening between a fixed end and a free end of the first locking member (3), a second locking member (5) formed as a protrusion to be engaged with the locking portion (31) in the second connector (40), and an unlocking member (7) held to be movable in the second connector (40). The second locking member (5) and the unlocking member (7) are located at positions separated from each other in a front-back direction which is the direction of mating in a locked state.

The procedure of unlocking in the connector locking mechanism included in the electrical connector (100) disclosed in the specification of U.S. Patent Application Publication No. 2015/0118886 includes (i) moving forward the unlocking member (7) located at a position separated from the first locking member (3) in the front-back direction, (ii) sliding the unlocking member (7) under the cantilevered first locking member (3), (iii) raising at this time the free end of the first locking member (3) upward by the unlocking member (7), and (iv) disengaging the second locking member (5) from the locking portion (31) of the cantilevered first locking member (3) to achieve unlocking. Note that the reference numerals for describing U.S. Patent Application Publication No. 2015/0118886 are parenthesized for distinction from an embodiment of the invention of the present application.

In the technical field of connectors having the connector locking mechanism described above, downsizing of the connector locking mechanism has been pursued. Since the electrical connector (100) disclosed in the specification of U.S. Patent Application Publication No. 2015/0118886 above, for example, is configured such that the locking portion (31) of the cantilevered first locking member (3) having a length in the direction of mating between the first connector (30) and the second connector (40) is engaged with the second locking member (5). This raises a problem in that the total length of the connector locking mechanism in the direction of mating between the connectors increases. In other words, the electrical connector (100) disclosed in the specification of U.S. Patent Application Publication No. 2015/0118886 is configured such that the first locking member (3) and the second locking member (5) for locking and unlocking are arranged in line in the front-back direction which is the direction of mating. This raises the problem of an increased dimension in the direction of mating.

The present invention therefore has an object to provide a connector locking mechanism for locking a mated state when a first connector and a second connector are mated, the connector locking mechanism being downsized as compared with that of the conventional art, and a connector assembly including this connector locking mechanism.

### SUMMARY OF THE INVENTION

A connector locking mechanism according to the present invention is a connector locking mechanism for locking a first connector and a second connector. The first connector includes a cantilevered locking member extending in a first direction which is a direction of mating with the second connector. A first locking shaped portion is formed in the locking member, and a first unlocking portion which is an inclined surface is formed between a fixed end of the locking member and the first locking shaped portion. The second connector includes an unlocking member held to be movable in the first direction which is the direction of mating with the first connector. The second connector includes a second locking shaped portion to be engaged with the first locking shaped portion formed in the locking member. A second unlocking portion which is an inclined surface to be brought into opposite contact with the inclined surface of the first unlocking portion included in the first connector when the second connector is mated with or withdrawn from the first connector is formed in the unlocking member. The locking member and the unlocking member are located at positions overlapped in a third direction orthogonal to the first direction in a locked state.

In other words, the conventional connector locking mechanism disclosed in the specification of U.S. Patent Application Publication No. 2015/0118886 mentioned above has an arrangement relationship of “a fulcrum (the fixed end of the first locking member (3))—a point of load (the position at which the second locking member (5) and the locking portion (31) are engaged)—a point of effort (the position at which the unlocking member (7) raises the first locking member (3))', while the connector locking mechanism according to the present invention has an arrangement of “a fulcrum (the fixed end of the locking member)—a point of effort (the position at which the second unlocking portion is in opposite contact with the first unlocking portion)—a point of load (the position at which the first locking shaped portion and the second locking shaped portion are engaged)”. Thus, the amount of displacement of the point of load in the vertical direction is larger than that in the conventional art, achieving a small amount of movement of the unlocking member in the horizontal direction.

In the conventional connector locking mechanism disclosed in the specification of U.S. Patent Application Publication No. 2015/0118886 mentioned above, the second locking member (5) and the unlocking member (7) are arranged at separate positions in the front-back direction in the locked state, and sliding is performed such that they are overlapped on each other, thereby achieving unlocking. In contrast, in the connector locking mechanism according to the present invention, the locking member and the unlocking member are overlapped in the vertical direction when in the locked state, and unlocking can be achieved by pulling out the unlocking member by a small amount. This can reduce the total length of the locking mechanism in the locked state.

The conventional connector locking mechanism disclosed in the specification of U.S. Patent Application Publication No. 2015/0118886 mentioned above requires two motions of pushing the unlocking member (7) forward and then pulling the second connector (40) backward, while the connector locking mechanism according to the present invention can achieve unlocking and enables the second connector to be withdrawn backward from the first connector in one motion of pulling the unlocking member backward.

In the connector locking mechanism according to the present invention, the first unlocking portion and the first locking shaped portion formed in the first connector can be arranged in parallel in the first direction.

In the connector locking mechanism according to the present invention, the locking member can be formed by cutting out part of a metal shell constituting an outer enclosure of the first connector, and the inclined surface of the first unlocking portion included in the locking member can be formed by bending the locking member.

In the connector locking mechanism according to the present invention, the second connector can have a restricting portion that restricts a relative moving range of the unlocking member with respect to the second connector when the unlocking member moves in the first direction to transition to an unlocked state and then abuts on part of the second connector.

In the connector locking mechanism according to the present invention, the first unlocking portion of the locking member included in the first connector and the second unlocking portion of the unlocking member included in the second connector can each have inclined surfaces to be brought into opposite contact when the unlocking member is moved in the first direction.

The connector locking mechanism according to the present invention can further include an elastic member that exerts an elastic force for moving the unlocking member to return to an initial position after the unlocking member included in the second connector moves in the first direction to transition to an unlocked state.

The present invention includes a connector assembly including the connector locking mechanism described above and being formed by mating the first connector and the second connector with each other.

### Advantageous Effect of Invention

According to the present invention, a connector locking mechanism for locking a mated state when a first connector and a second connector are mated, the connector locking mechanism being downsized as compared with that of the conventional art, and a connector assembly including this connector locking mechanism can be provided.

### BRIEF DESCRIPTION OF THE DRAWINGS

FIG. 1 is an outer perspective view of a first connector according to the present embodiment as viewed from upper right on the front side;

FIG. 2 is an outer perspective view of the first connector according to the present embodiment as viewed from lower left on the back side;

FIG. 3 is a right side view of the first connector according to the present embodiment;

FIG. 4 is a top view of the first connector according to the present embodiment;

FIG. 5 is a cross-sectional view showing a cross section taken along the line 5-5 in FIG. 4;

FIG. 6 is a cross-sectional view showing a cross section taken along the line 6-6 in FIG. 4;

FIG. 7 is a cross-sectional view showing a cross section taken along the line 7-7 in FIG. 4;

FIG. 8 is an outer perspective view of a second connector according to the present embodiment as viewed from upper right on the front side;

FIG. 9 is an outer perspective view of the second connector according to the present embodiment as viewed from lower left on the back side;

FIG. 10 is a right side view of the second connector according to the present embodiment;

FIG. 11 is a top view of the second connector according to the present embodiment;

FIG. 12 is an exploded perspective view of the second connector according to the present embodiment as viewed from upper right on the front side;

FIGS. 13(a) and 13(b) are perspective views for describing operation of an unlocking member included in the second connector according to the present embodiment, the unlocking member being positioned on the front side in FIG. 13(a), and the unlocking member being positioned on the back side in FIG. 13(b);

FIG. 14(a) and 14(b) are right side views for describing operation of the unlocking member included in the second connector according to the present embodiment, the unlocking member being positioned on the front side in FIG. 14(a), and the unlocking member being positioned on the back side in FIG. 14(b);

FIG. 15 is an outer perspective view of the first connector and the second connector constituting a connector assembly according to the present embodiment as viewed from upper right on the front side, showing a state in which the first connector and the second connector are not mated yet;

FIG. 16 is a right side view of the first connector and the second connector constituting the connector assembly according to the present embodiment as viewed from the right side, showing the state in which the first connector and the second connector are not mated yet;

FIG. 17 is a top view of the first connector and the second connector constituting the connector assembly according to the present embodiment as viewed from above, showing the state in which the first connector and the second connector are not mated yet;

FIG. 18 is a cross-sectional view showing a cross section taken along the line 18-18 in FIG. 17;

FIG. 19 is a cross-sectional view showing a cross section taken along the line 19-19 in FIG. 17;

FIG. 20 is a cross-sectional view showing a mated state of the first connector and the second connector shown in FIG. 18;

FIGS. 21(a) and 21(b) are cross-sectional views showing the mated state of the first connector and the second connector shown in FIG. 19, FIG. 21(a) showing a state in which the first connector and the second connector are completely mated, and FIG. 21(b) showing a state in which the first connector and the second connector are being mated;

FIGS. 22(a1) and 22(a2) are diagrams for describing a mechanism when the first connector and the second connector constituting the connector assembly according to the present embodiment are mated, and FIGS. 22(b1) and 22(b2) are diagrams for describing the connector locking mechanism of the conventional art in the specification of U.S. Patent Application Publication No. 2015/0118886 as a comparative example;

FIG. 23 is a diagram showing one of various modification examples that can be taken by the second connector of the present invention and is an outer perspective view of a second connector according to a modification as viewed from upper right on the front side;

FIG. 24 is a diagram showing the one of various modification examples that can be taken by the second connector of the present invention and is an outer perspective view of the second connector according to the modification as viewed from lower left on the back side;

FIG. 25 is a diagram showing the one of various modification examples that can be taken by the second connector of the present invention and is a right side view of the second connector according to the modification as viewed from the right side;

FIG. 26 is a diagram showing the one of various modification examples that can be taken by the second connector of the present invention and is a top view of the second connector according to the modification as viewed from above;

FIG. 27 is a diagram showing the one of various modification examples that can be taken by the second connector of the present invention and is an exploded perspective view of the second connector according to the modification as viewed from upper right on the front side;

FIG. 28 is a top view showing an electrical connector in the specification of U.S. Patent Application Publication No. 2015/0118886; and

FIG. 29 is a perspective view showing the electrical connector in the specification of U.S. Patent Application Publication No. 2015/0118886.

### DETAILED DESCRIPTION OF THE INVENTION

Hereinafter, a suitable embodiment for carrying out the present invention will be described with reference to the drawings. Note that a first direction, a second direction, and a third direction are defined in the present invention. In the drawings, respective directions are indicated as an X direction, a Y direction, and a Z direction for ease of description. In the present specification, the first direction is the front-back direction. In the drawings, the front-back direction is indicated as the X direction. In particular, the front side is referred to as the +X direction, and the back side is referred to as the −X direction. In the present specification, the second direction is the lateral direction. In the drawings, the lateral direction is indicated as the Y direction. In particular, the right side is referred to as the +Y direction, and the left side is referred to as the −Y direction. In the present specification, the third direction is the vertical direction. In the drawings, the vertical direction is indicated as the Z direction. In particular, the upper side is referred to as the +Z direction, the lower side is referred to as the −Z direction.

Each embodiment below is not intended to limit the invention according to each claim, and all of combinations of features described in each embodiment are not necessarily essential to the solution of the invention.

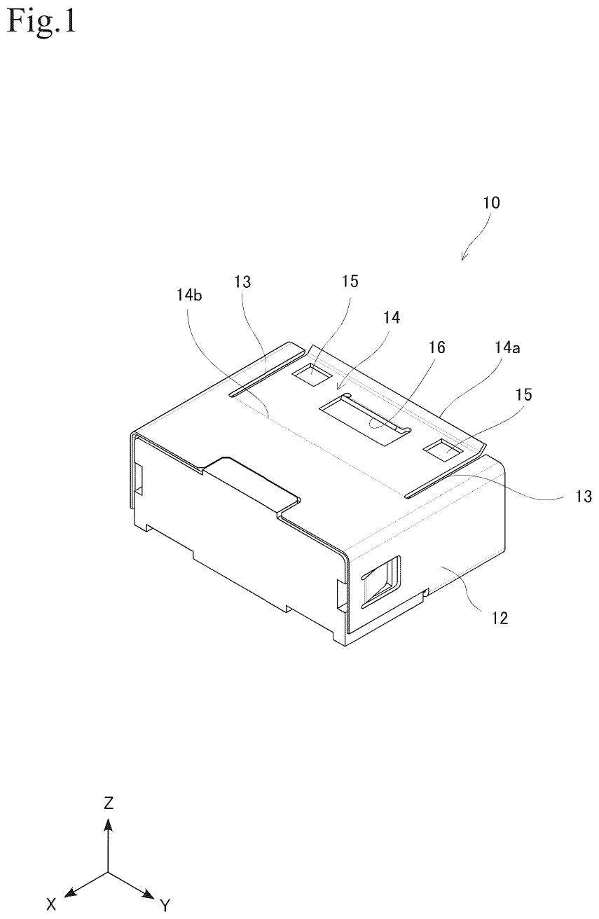

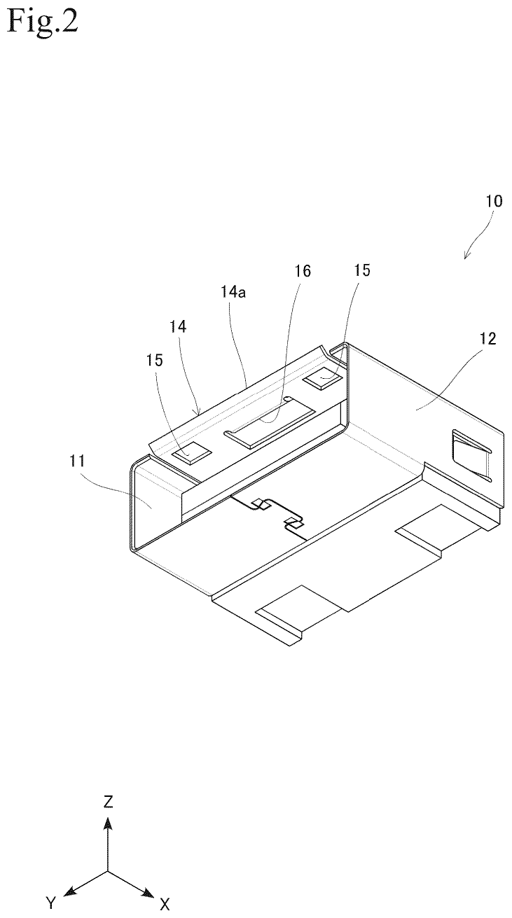

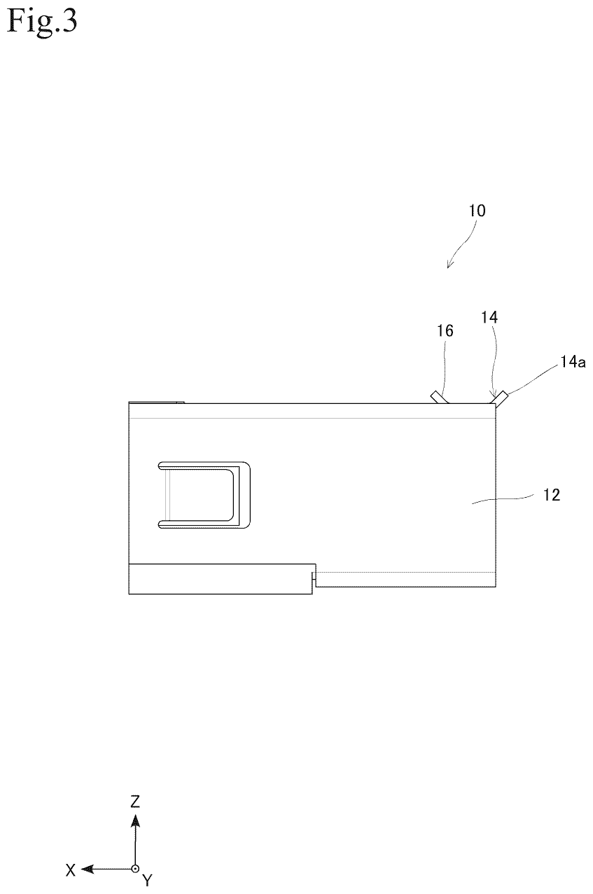

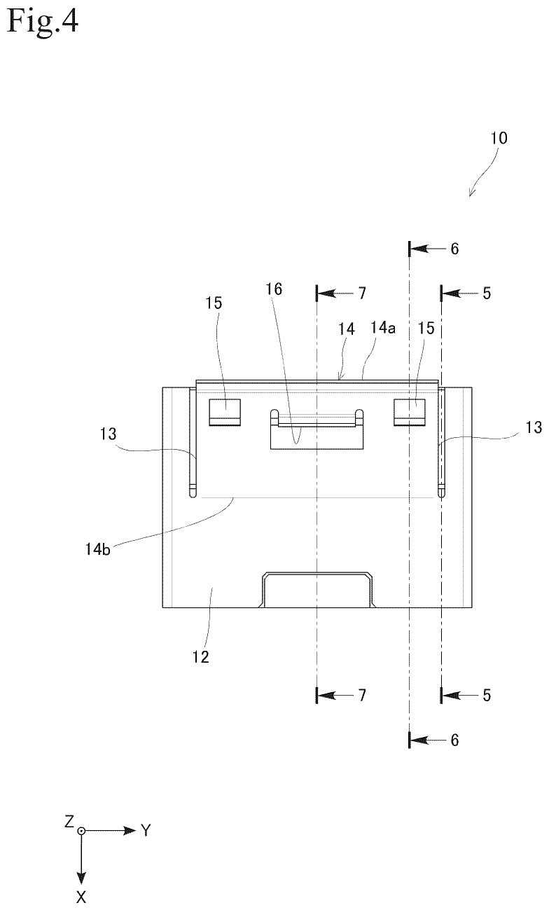

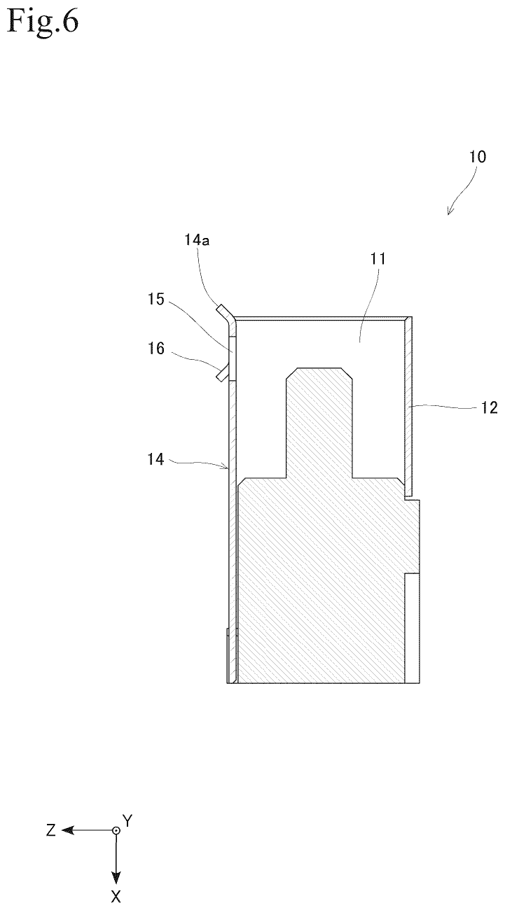

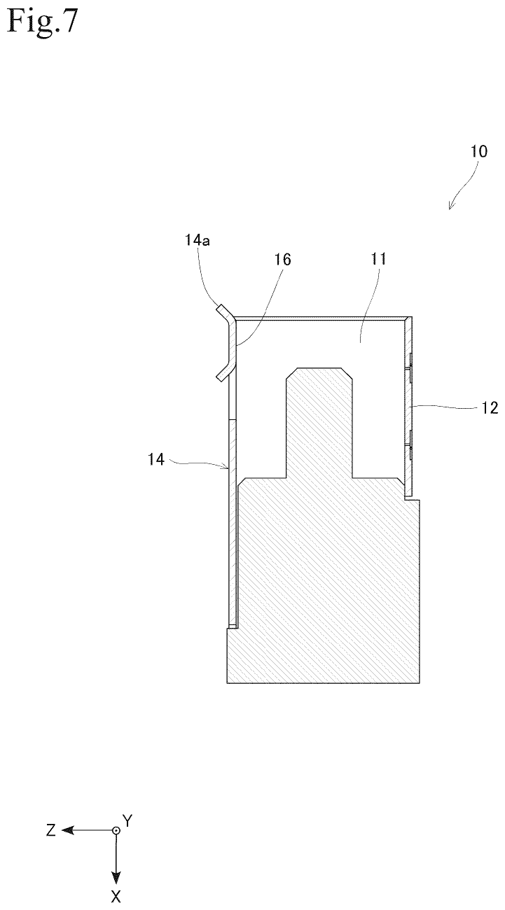

A first connector 10 according to the present embodiment will be described first with reference to FIGS. 1 to 7. The first connector 10 according to the present embodiment has an overall outer enclosure presenting a substantially cuboid shape and has formed on the back side a first mating opening 11 opened for mating with a second connector 20 which will be described later, as shown in FIGS. 1 and 2. An upper surface, left and right side surfaces, and a front side of a lower surface of the first connector 10 are formed by a metal shell 12 formed by bending a flat metal plate. This metal shell 12 constitutes a major portion of the substantially cuboid outer enclosure of the first connector 10.

Two cutout portions 13 formed by providing cutouts forward from the back side are formed in an upper surface of the metal shell 12 constituting the outer enclosure of the first connector 10 as shown in FIG. 1. A portion sandwiched between the two cutout portions 13 is formed as a cantilevered locking member 14 extending in the first direction (the −X direction) which is a direction of mating with the second connector 20 which will be described later.

A back end of the locking member 14 formed on the upper surface of the first connector 10 serves as a free end 14a, and a location on a line that connects cutout terminal ends on the front side of the two cutout portions 13 serves as a fixed end 14b. Therefore, in a case in which the cantilevered locking member 14 extending in the −X direction receives an external force in the vertical direction, the locking member 14 bows with a position in the vicinity of the fixed end 14b serving as a fulcrum. However, the cantilevered locking member 14 exerts an elastic force and thus returns to a horizontal state with respect to the upper surface of the metal shell 12 in a case in which the external force in the vertical direction disappears. That is, the locking member 14 is configured to maintain the horizontal state with respect to the upper surface of the metal shell 12 in a normal state in which an external force is not applied.

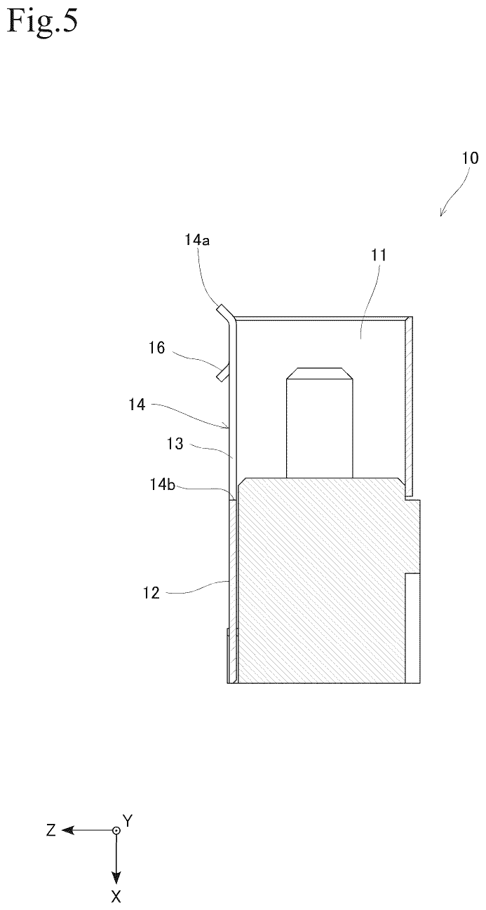

The locking member 14 has formed therein two engagement holes 15 opened at left and right positions on the back side. These two engagement holes 15 function as first locking shaped portions of the present invention. The locking member 14 also has formed therein a first unlocking portion 16 which is an inclined surface between the fixed end 14b of the locking member 14 and the two engagement holes 15 which are the first locking shaped portions (see FIGS. 5 to 7).

The two engagement holes 15 serving as the first locking shaped portions of the present invention have a function of bringing the first connector 10 and the second connector 20 into a locked state when second locking shaped portions (two projections 22a) included in the second connector 20 which will be described later are engaged with. On the other hand, the first unlocking portion 16 included in the locking member 14 is formed with the inclined surface facing downward by bending the locking member 14. The inclined surface of the first unlocking portion 16 has a function of causing the locking member 14 to bow upward upon receipt of an upward (the +Z direction) force from a second unlocking portion 23b included in the second connector 20 which will be described later.

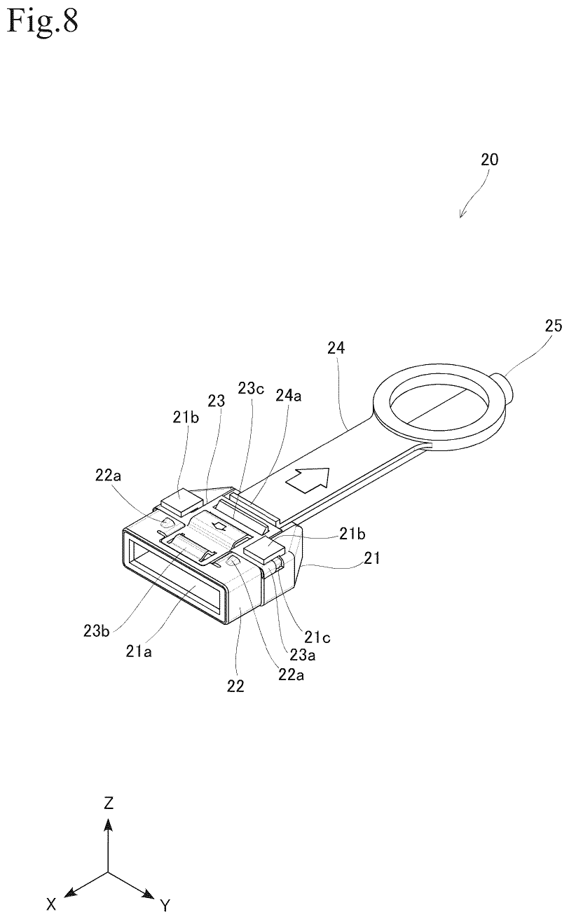

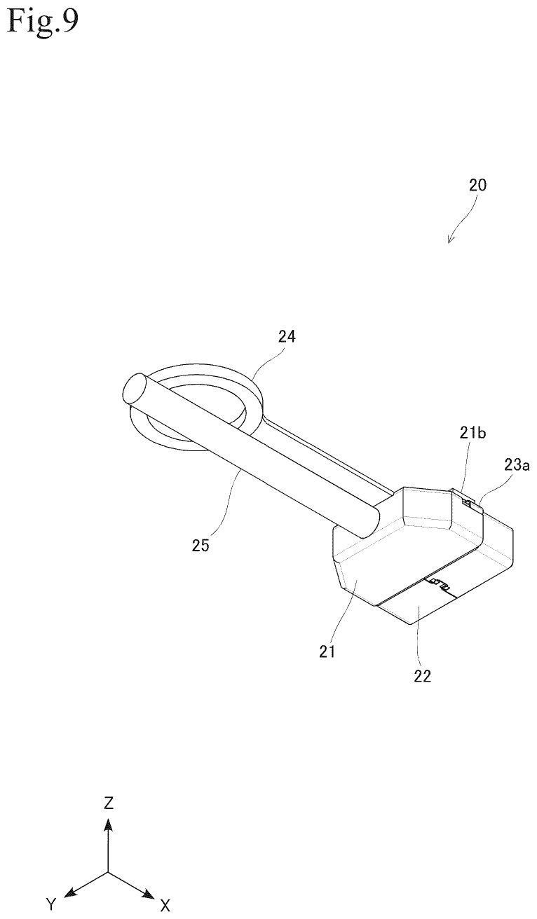

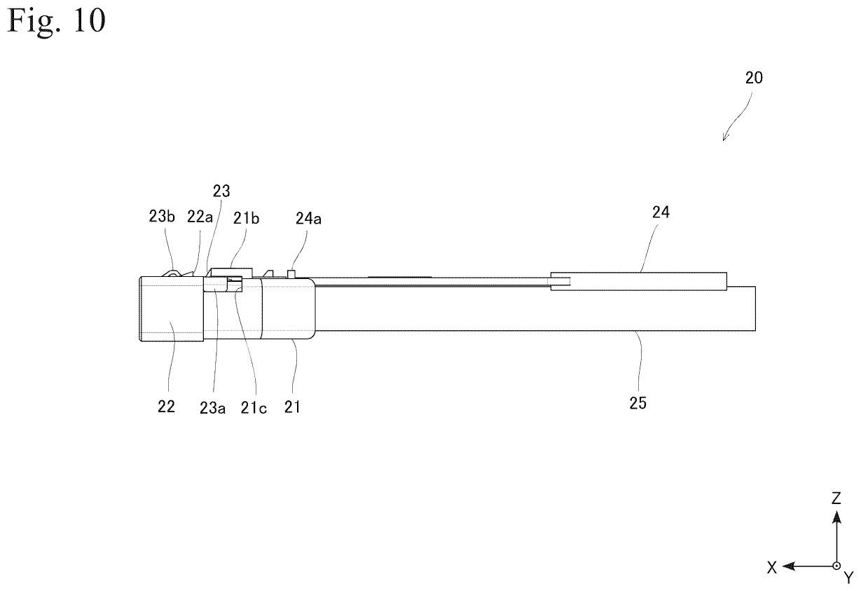

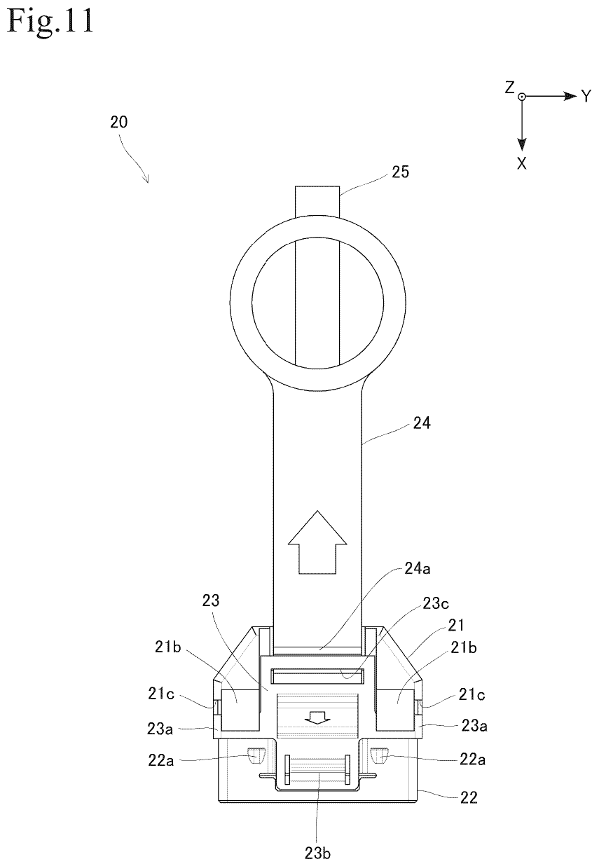

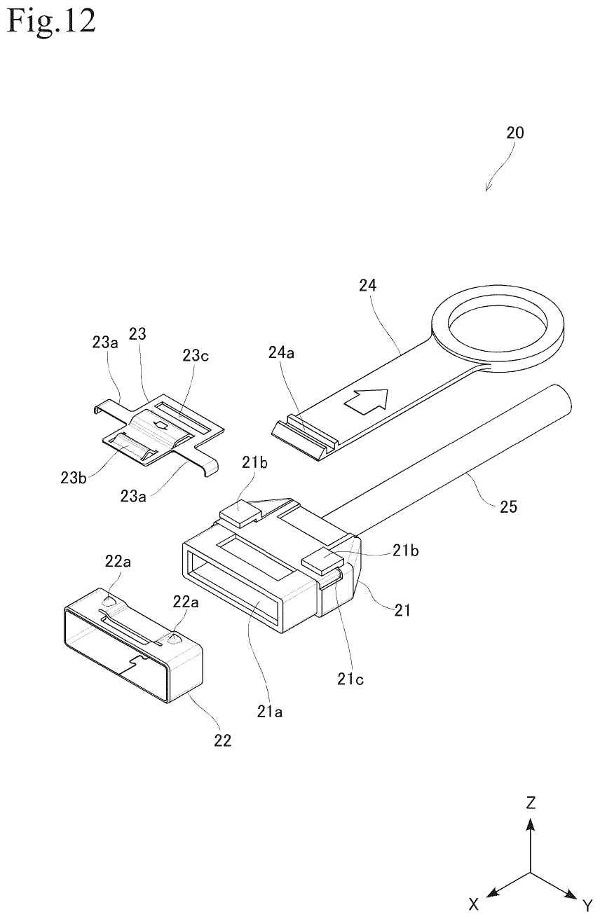

The first connector 10 according to the present embodiment has been described above. The second connector 20 according to the present embodiment will now be described with reference to FIGS. 8 to 14(b). The second connector 20 according to the present embodiment has a second connector housing 21 with an electrical cord 25 inserted on the back side, a metallic frame member 22 fitted on the front side of the second connector housing 21, an unlocking member 23 arranged to be movable in the front-back direction over the second connector housing 21, and an operating member 24 attached to the unlocking member 23 to perform a moving operation of the unlocking member 23 in the front-back direction (the X direction), as shown in FIG. 12.

The second connector housing 21 has formed therein a second mating opening 21a opened on the front side for mating with the first connector 10 as shown in FIG. 8, FIG. 12, and the like. The frame member 22 can be fitted on and fixed to the front side of the second connector housing 21. Holding shaped portions 21b for holding the unlocking member 23 to be movable in the front-back direction and restricting portions 21c for restricting the amount of movement in the front-back direction of the unlocking member 23 held by these holding shaped portions 21b are further formed at left and right positions on the upper side of the second connector housing 21.

The frame member 22 has two projections 22a formed at left and right positions on the upper side. The two projections 22a are parts that function as second locking shaped portions of the present invention included in the second connector 20. Therefore, when the first connector 10 and the second connector 20 are mated, the two projections 22a are engaged with the two engagement holes 15 serving as the first locking shaped portions formed in the locking member 14 of the first connector 10, thereby achieving the locked state of the first connector 10 and the second connector 20.

The unlocking member 23 is a member held to be movable in the first direction (the X direction) which is the direction of mating with the first connector 10. This unlocking member 23 includes a pair of arms 23a extending in the lateral direction. The pair of arms 23a are held by the holding shaped portions 21b of the second connector housing 21, thereby enabling a longitudinal movement of the unlocking member 23 over the second connector housing 21. The pair of arms 23a move within a range in which the restricting portions 21c of the second connector housing 21 are formed and abut on parts of wall surface shapes constituting the restricting portions 21c, so that a movable range in a backward movement is defined. A movable range in a forward movement of the unlocking member 23 is defined by a back end of the frame member 22. That is, a relative moving range of the unlocking member 23 of the present embodiment with respect to the second connector 20 is restricted by the restricting portions 21c formed in the second connector housing 21 and the back end of the frame member 22.

The unlocking member 23 also has formed at a front center position the second unlocking portion 23b which is an inclined surface. The inclined surface of the second unlocking portion 23b included in the unlocking member 23 is formed with the surface facing upward by bending the unlocking member 23. The inclined surface of the second unlocking portion 23b is an inclined surface to be brought into opposite contact with the inclined surface of the first unlocking portion 16 included in the first connector 10 when the second connector 20 is mated with or withdrawn from the first connector 10. Therefore, the inclined surface of the second unlocking portion 23b has a function of exerting an upward (the +Z direction) force on the first unlocking portion 16 included in the first connector 10 which will be described later, thereby causing the locking member 14 to bow upward.

The unlocking member 23 further has at a back center position an attachment hole 23c for attaching the operating member 24. As shown in FIG. 12, the operating member 24 has an attachment groove 24a on the front side. By fitting a groove shape of this attachment groove 24a into the attachment hole 23c, coupling between the unlocking member 23 and the operating member 24 is achieved. A user is able to perform a moving operation of the unlocking member 23 in the front-back direction (the X direction) by pushing the operating member 24 forward or pulling the operating member 24 backward.

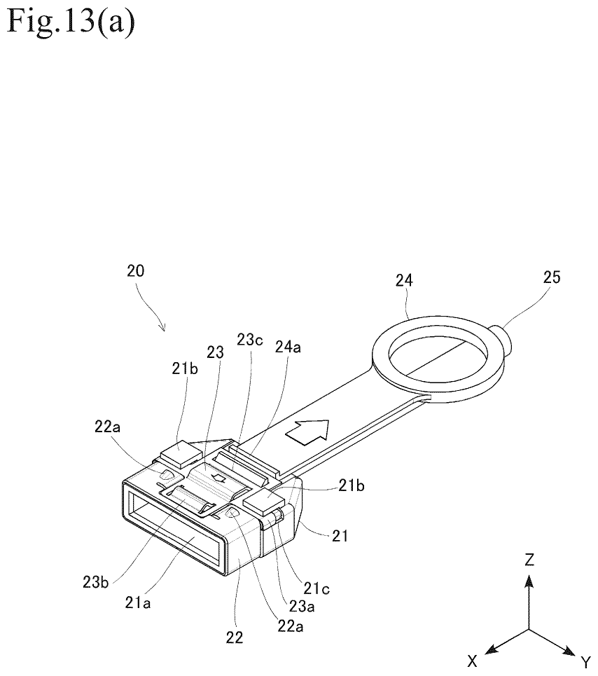

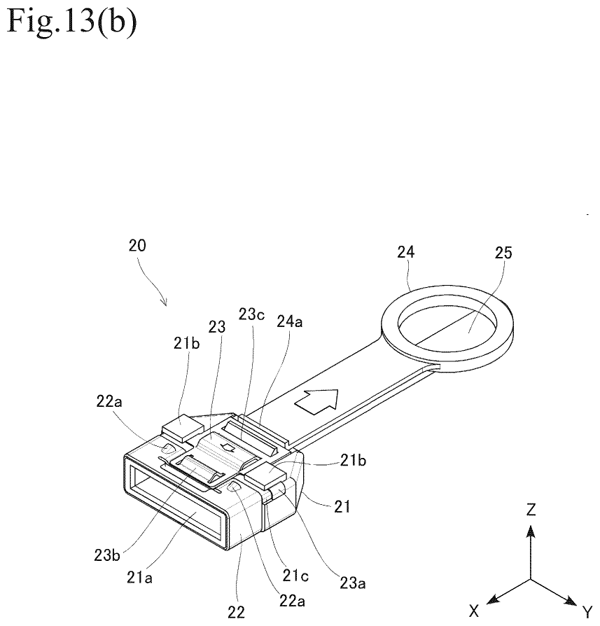

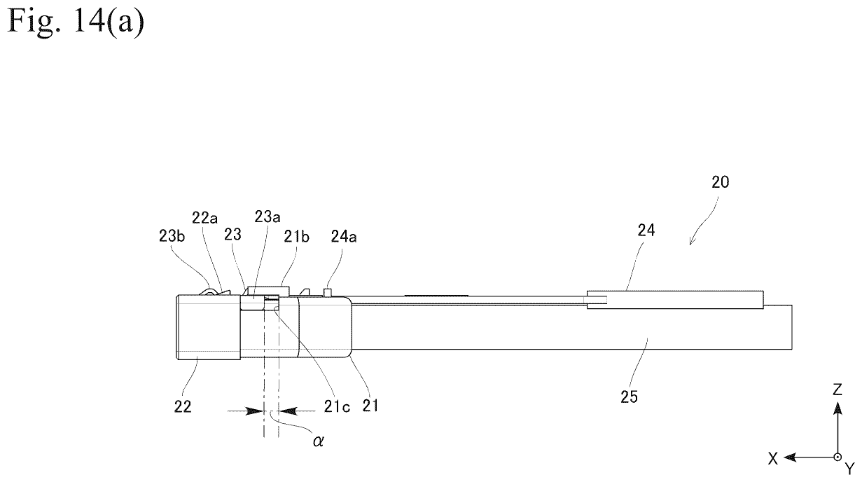

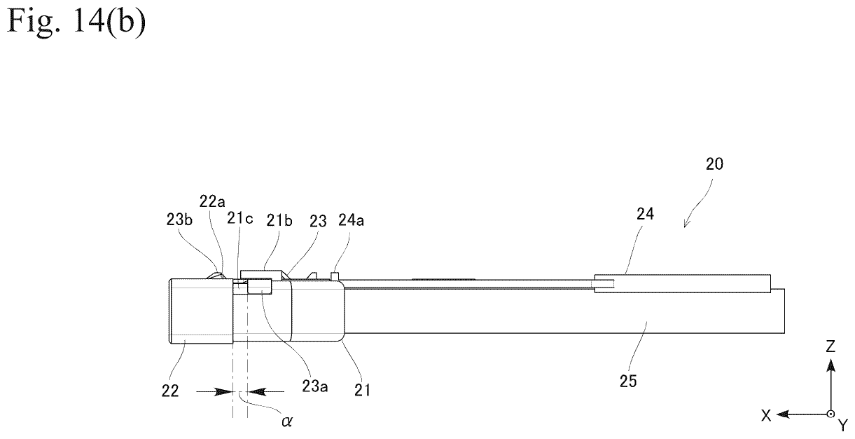

As described above, for the unlocking member 23 of the second connector 20, the movable range in the backward movement is defined by the wall surface shapes constituting the restricting portions 21c, and the movable range in the forward movement is defined by the back end of the frame member 22. Herein, FIG. 13(a) and FIG. 14(a) show a case in which the unlocking member 23 of the second connector 20 is positioned on the front side in the movable range, and FIG. 13(b) and FIG. 14(b) show a case in which the unlocking member 23 of the second connector 20 is positioned on the back side in the movable range. In particular, as shown in FIGS. 14(a) and 14(b), a movable dimension of the unlocking member 23 in the front-back direction is movable by the distance indicated by the sign a. The second unlocking portion 23b which is the inclined surface formed in the unlocking member 23 moves by the amount of movement of this distance α, which at least enables the locked state of the locking member 14 and the unlocking member 23 to be switched into an unlocked state.

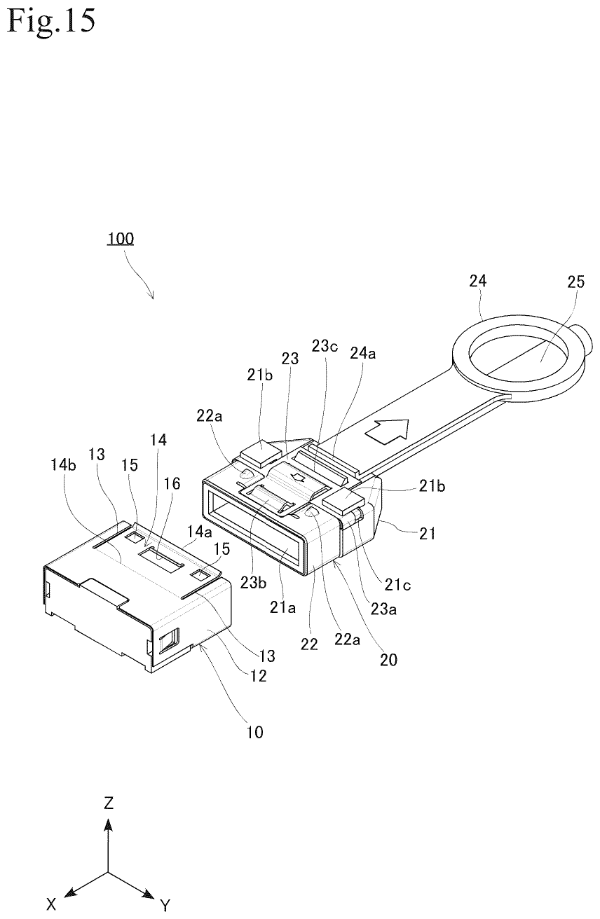

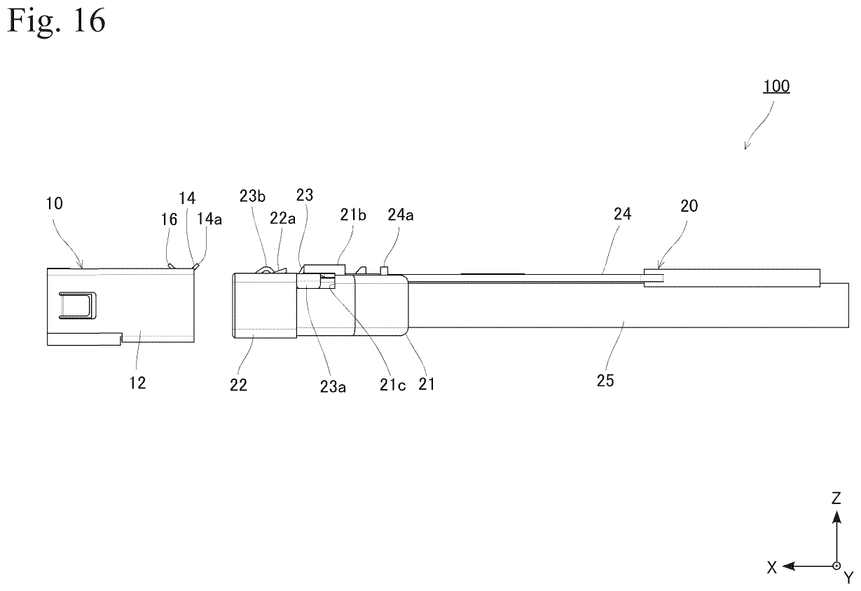

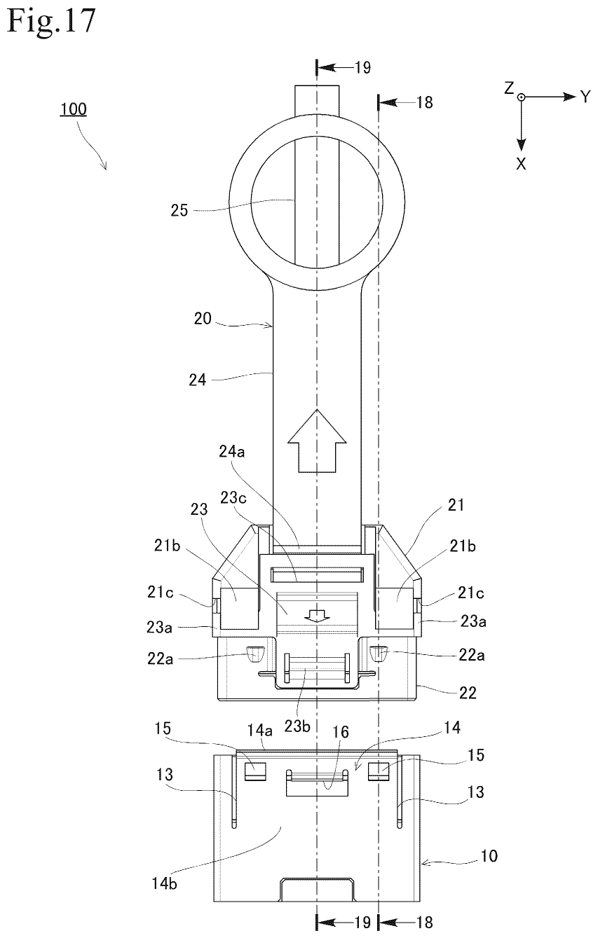

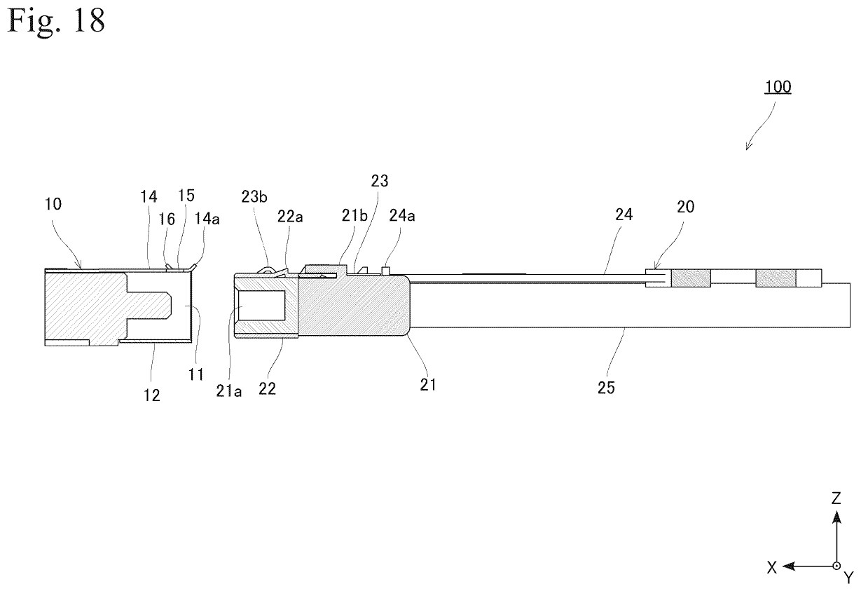

The second connector 20 according to the present embodiment has been described above. A connector assembly 100 according to the present embodiment will now be described with reference to FIGS. 15 to 21(b).

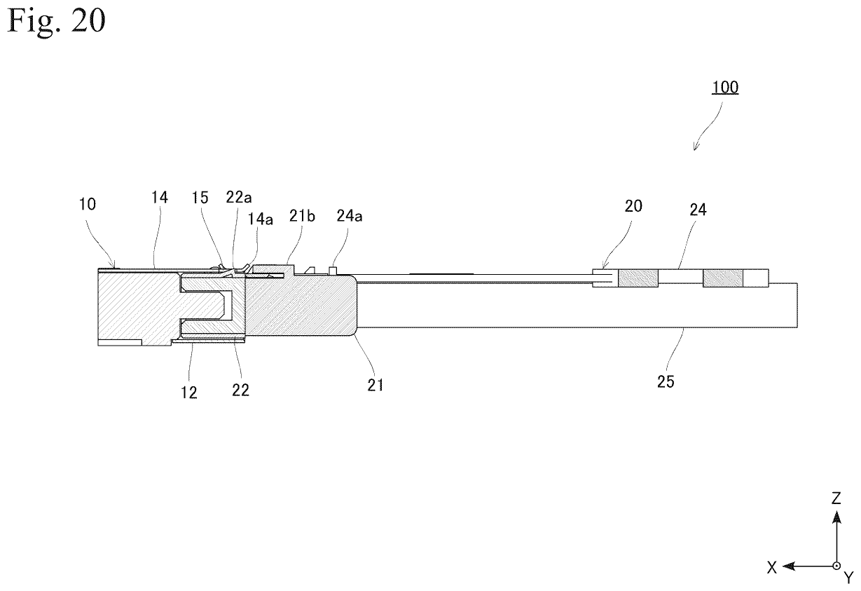

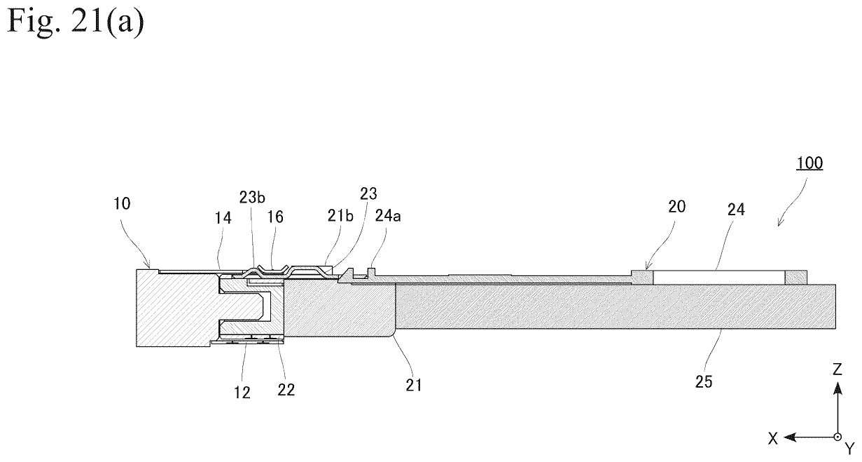

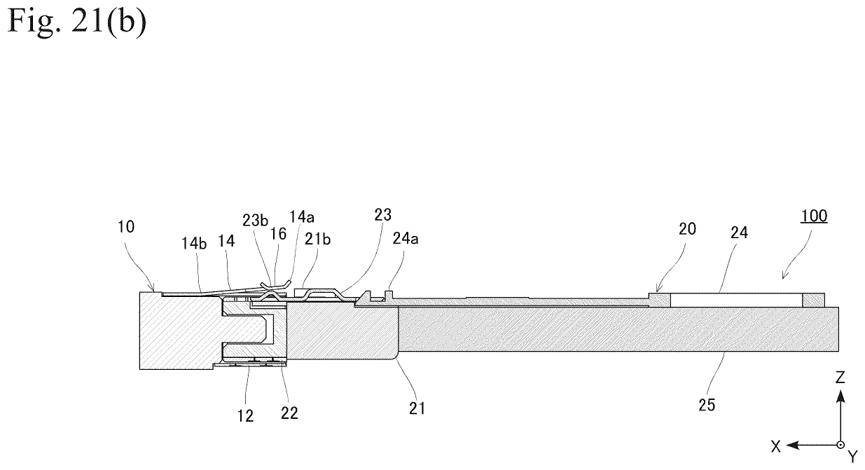

As shown in FIGS. 15 to 19, the first connector 10 and the second connector 20 can be mated by oppositely arranging the first mating opening 11 opened on the back side of the first connector 10 and the second mating opening 21a opened on the front side of the second connector 20 and then moving the second connector forward (the +X direction) with respect to the first connector 10. At this time, when the user inserts the unlocking member 23 of the second connector 20 as it is while holding the state in which the unlocking member 23 is positioned on the front side in the movable range, the second unlocking portion 23b included in the second connector 20 and the first unlocking portion 16 included in the first connector 10 have their inclined surfaces brought into opposite contact with each other as shown in FIG. 21(b). At this time, since the locking member 14 having formed therein the inclined surface of the first unlocking portion 16 is formed as a cantilevered member, the locking member 14 bows upward when the downward inclined surface of the first unlocking portion 16 receives an upward (the +Z direction) force from the upward inclined surface of the second unlocking portion 23b. When the second connector 20 is further inserted from this state shown in FIG. 21(b) toward the first connector 10, contact between the inclined surface of the first unlocking portion 16 and the inclined surface of the second unlocking portion 23b is released, and a mated state as shown in FIG. 21(a) is achieved. At this time, the locking member 14 of the first connector 10 has returned to the horizontal state with the force from the unlocking member 23 released, and as shown in FIG. 20, the two projections 22a included in the second connector 20 are engaged with the two engagement holes 15 formed in the locking member 14 of the first connector 10, thereby achieving the locked state of the first connector 10 and the second connector 20. As described above, in the connector assembly 100 according to the present embodiment, bringing the first connector 10 and the second connector 20 into the mated state and the locked state can be achieved in one motion.

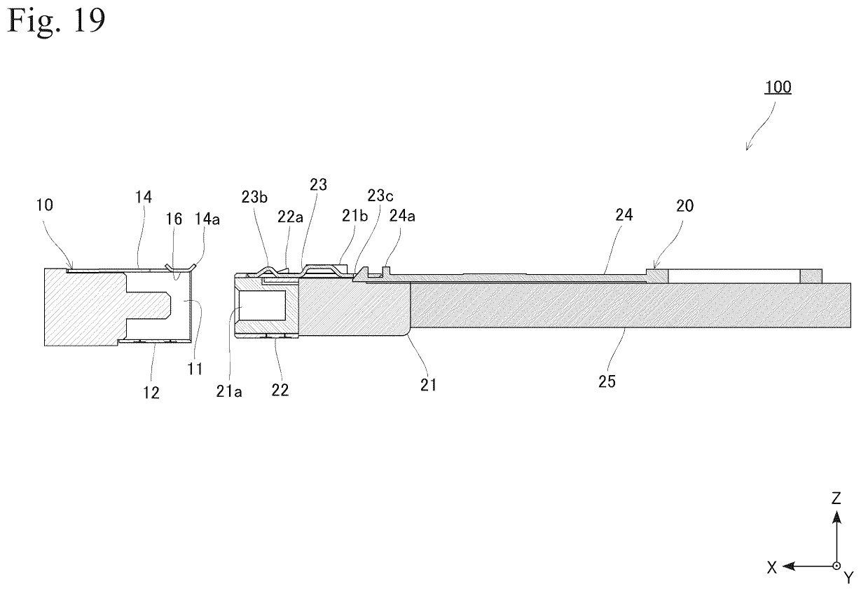

On the other hand, as shown in FIG. 20 and FIG. 21(a), unlocking of the mated state of the first connector 10 and the second connector 20 from the state in which the first connector 10 and the second connector 20 are mated in the locked state can be performed by the user in one motion by pulling the operating member 24 backward (the −X direction). In other words, when the user pulls the operating member 24 backward (the −X direction) from the locked state shown in FIG. 21(a), the unlocking member 23 connected to the operating member 24 is moved backward (the −X direction) within the range of the distance α. When the unlocking member 23 is moved backward (the −X direction) within the range of the distance α, the second unlocking portion 23b included in the second connector 20 and the first unlocking portion 16 included in the first connector 10 have their inclined surfaces brought into opposite contact with each other as shown in FIG. 21(b). At this time, since the locking member 14 having formed therein the inclined surface of the first unlocking portion 16 is formed as a cantilevered member, the locking member 14 bows upward when the downward inclined surface of the first unlocking portion 16 receives an upward (the +Z direction) force from the upward inclined surface of the second unlocking portion 23b. When the locking member 14 bows upward, the engagement relationship shown in FIG. 20 between the two engagement holes 15 formed in the locking member 14 of the first connector 10 and the two projections 22a included in the second connector 20 is released, which brings a state in which locking of the first connector 10 and the second connector 20 is released. When the user continues pulling the operating member 24 backward (the −X direction) as it is from this state, the first connector 10 and the second connector 20 transition from the state in FIG. 21(b) to the state in FIG. 19, achieving the operation of withdrawing the second connector 20 from the first connector 10 in one motion.

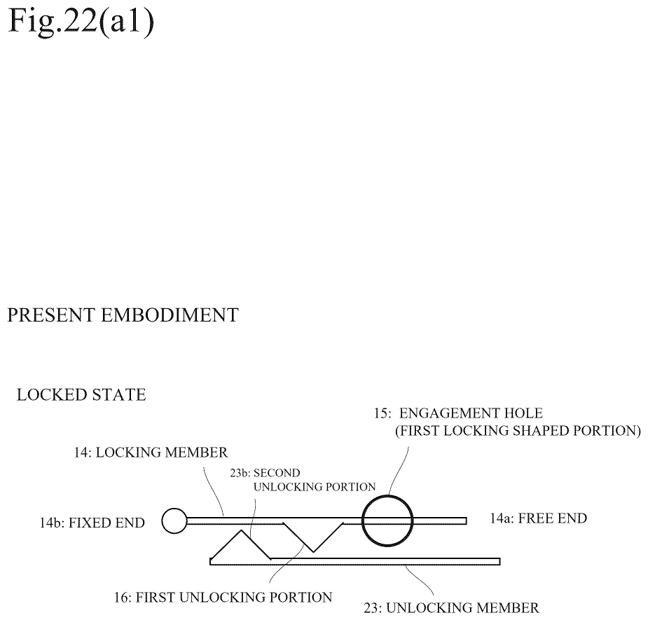

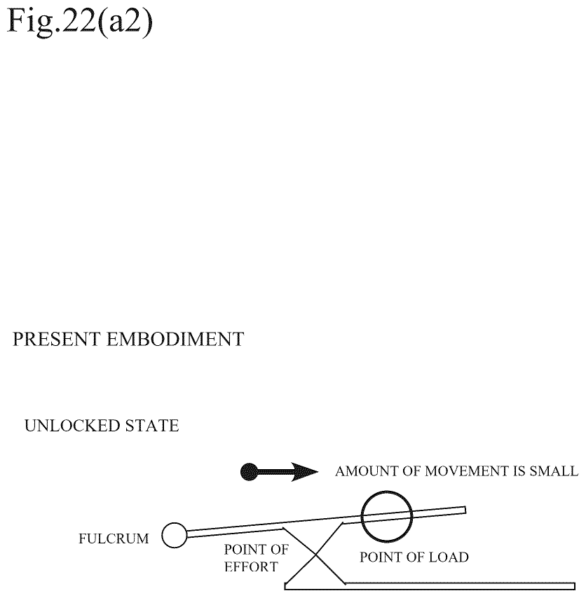

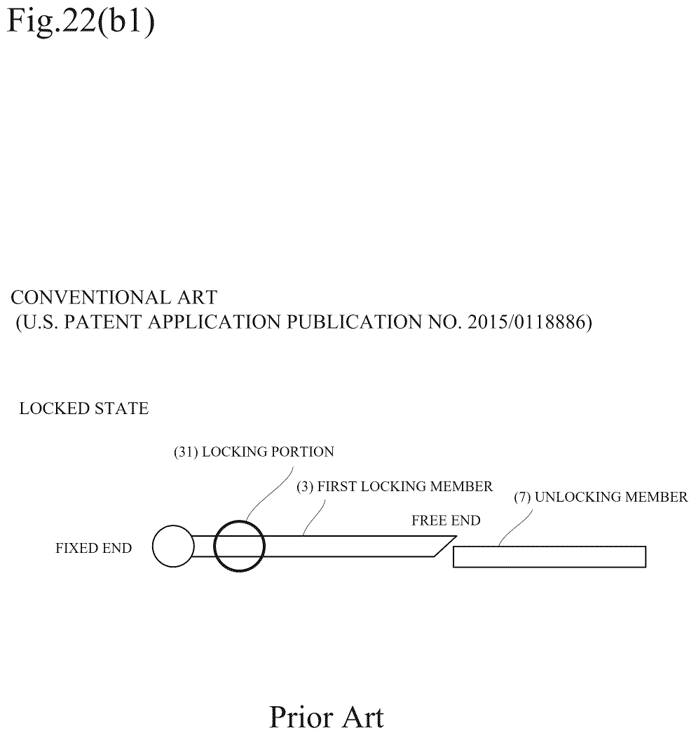

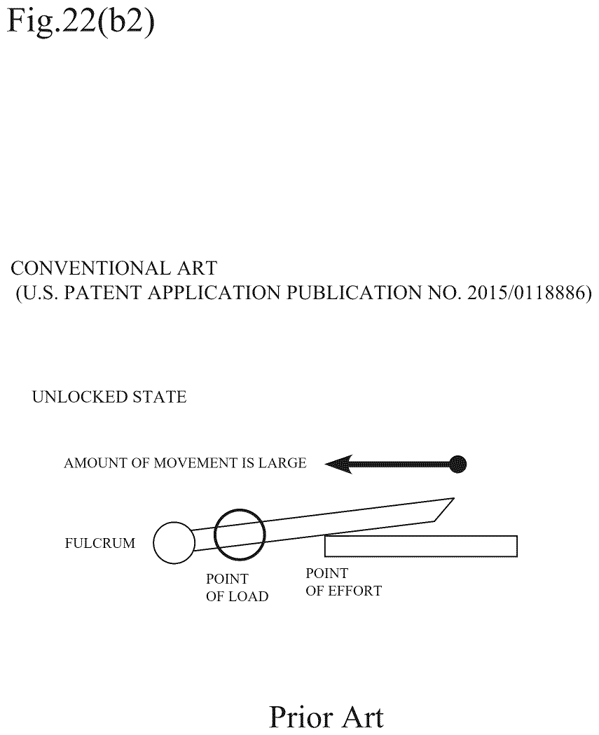

Subsequently, by adding FIGS. 22(a1), 22(a2), 22(b1), and 22(b2) to the reference drawings, the connector locking mechanism for locking the first connector 10 and the second connector 20 will be described. Herein, FIGS. 22(a1) and 22(a2) are schematic diagrams for describing the connector locking mechanism of the present embodiment, FIG. 22(a1) showing the locked state, and FIG. 22(a2) showing the unlocked state. FIGS. 22(b1) and 22(b2) are schematic diagrams for describing the connector locking mechanism of the conventional art disclosed in the specification of U.S. Patent Application Publication No. 2015/0118886, FIG. 22(b1) showing the locked state, and FIG. 22(b2) showing the unlocked state.

As shown in FIGS. 22(a1), 22(a2), 22(b1), and 22(b2), the connector locking mechanism according to the conventional art disclosed in the specification of U.S. Patent Application Publication No. 2015/0118886 mentioned above has an arrangement relationship of “the fulcrum (the fixed end of the first locking member (3))—the point of load (the position at which the second locking member (5) and the locking portion (31) are engaged)—the point of effort (the position at which the unlocking member (7) raises the first locking member (3)) “. In this case, the distance between the fulcrum and the point of load is close, and the distance between the point of effort and the point of load is great, so that the amount of movement of the unlocking member (7) which exerts a force on the point of effort needs to be increased in order to move the point of load to bring the unlocked state. That is, the conventional art fails to achieve the unlocked state unless the amount of movement of the unlocking member (7) is increased. In contrast, the connector locking mechanism according to the present embodiment adopts an arrangement relationship of “the fulcrum (the fixed end 14b of the locking member 14)—the point of effort (the position at which the second unlocking portion 23b is in opposite contact with the first unlocking portion 16)—the point of load (the position at which the first locking shaped portions (the two engagement holes 15) and the second locking shaped portions (the two projections 22a) are engaged)”. In particular, in the present embodiment, the point of effort is located at the center, and the point of load is arranged separately on the free end side. Thus, the amount of displacement of the point of load in the vertical direction is greater than that in the conventional art because of the principle of leverage, which can yield an advantage in that the amount of movement of the unlocking member in the horizontal direction is small.

In the conventional connector locking mechanism disclosed in the specification of U.S. Patent Application Publication No. 2015/0118886 mentioned above, the second locking member (5) and the unlocking member (7) are arranged at separate positions in the front-back direction in the locked state, and sliding is performed such that they are overlapped on each other, thereby achieving unlocking. In contrast, in the connector locking mechanism according to the present embodiment, the locking member 14 and the unlocking member 23 are overlapped in the vertical direction (the Z direction which is the third direction) when in the locked state, and unlocking can be achieved by pulling out the unlocking member 23 by a small amount. This can yield an advantage in that the total length of the locking mechanism in the locked state can be reduced.

The conventional connector locking mechanism disclosed in the specification of U.S. Patent Application Publication No. 2015/0118886 mentioned above requires two motions of pushing the unlocking member (7) forward and then pulling the second connector (40) backward. That is, in the conventional art, the direction in which the second connector (40) is pulled and the direction in which the unlocking member (7) is pushed are opposite. In contrast, in the connector locking mechanism according to the present embodiment, unlocking is achieved and the second connector 20 can be withdrawn backward from the first connector 10 in one motion of pulling the unlocking member 23 backward, as described above. That is, the direction in which the second connector 20 is withdrawn from the first connector 10 and the direction in which the unlocking member 23 is moved are the same direction in the present embodiment. This can yield an advantage of excellent operability. Note that this advantage is yielded by an arrangement relationship in which the first unlocking portion 16 and the first locking shaped portions (the two engagement holes 15) formed in the first connector 10 are arranged in parallel in the front—back direction (the X direction which is the first direction) in addition to the arrangement relationship of “the fulcrum (the fixed end 14b of the locking member 14) —the point of effort (the position at which the second unlocking portion 23b is in opposite contact with the first unlocking portion 16)—the point of load (the position at which the first locking shaped portions (the two engagement holes 15) and the second locking shaped portions (the two projections 22a) are engaged)” in the present embodiment described above.

Although the suitable embodiment of the present invention has been described above, the technical scope of the present invention is not limited to the scope described in the above embodiment. Various changes or alterations can be made to the above embodiment.

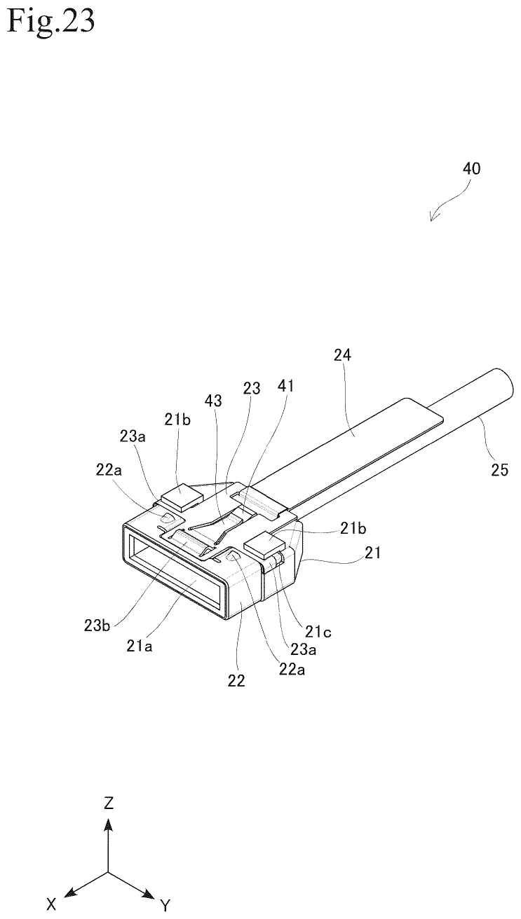

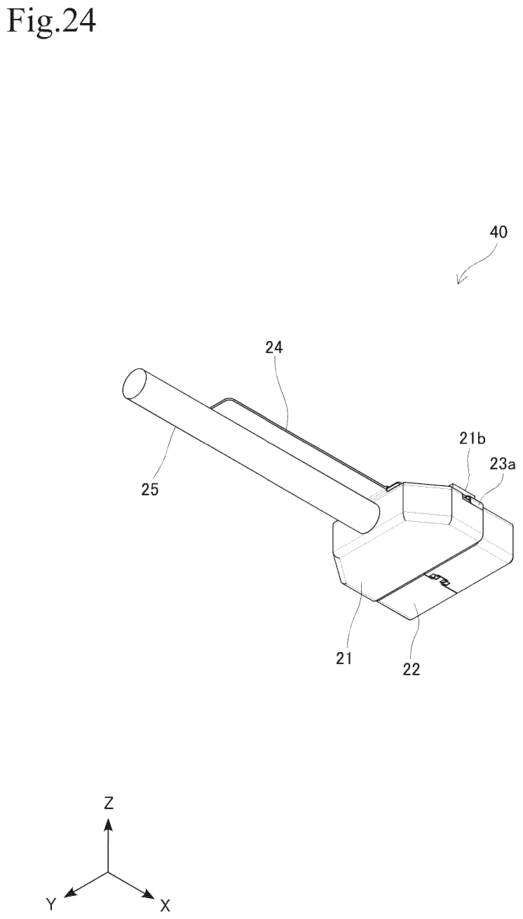

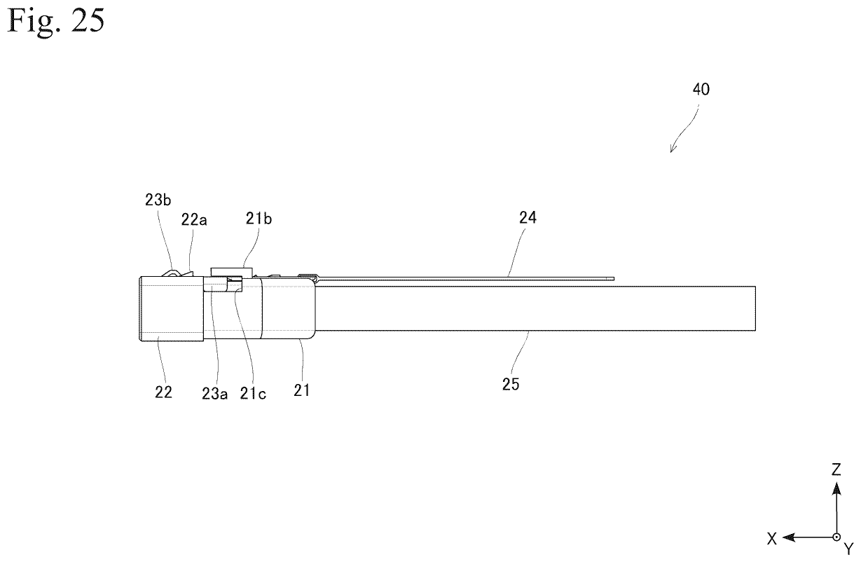

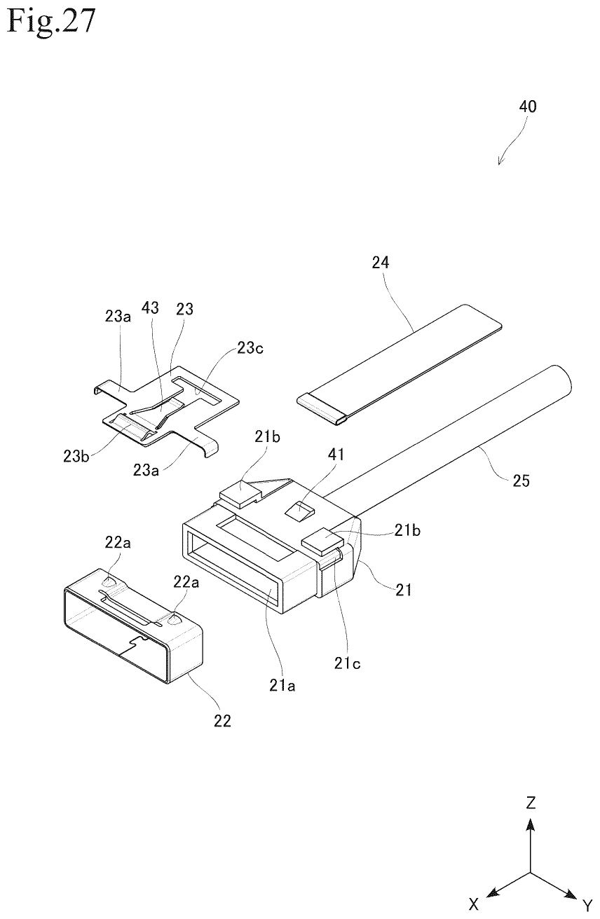

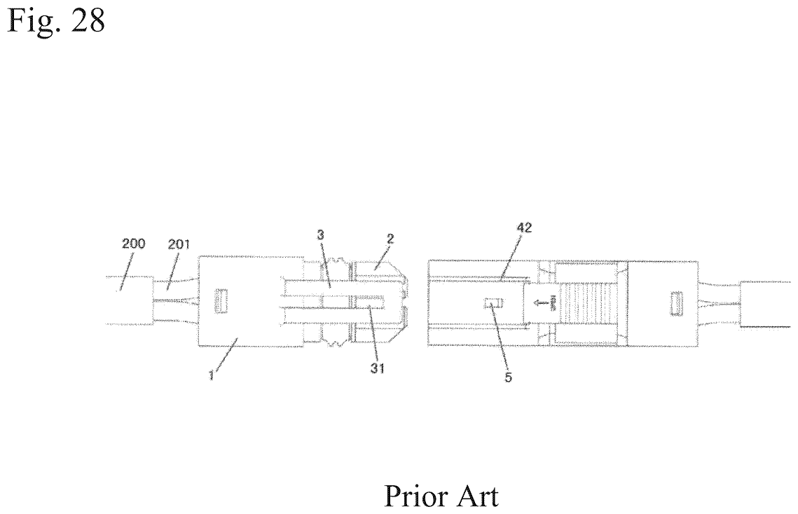

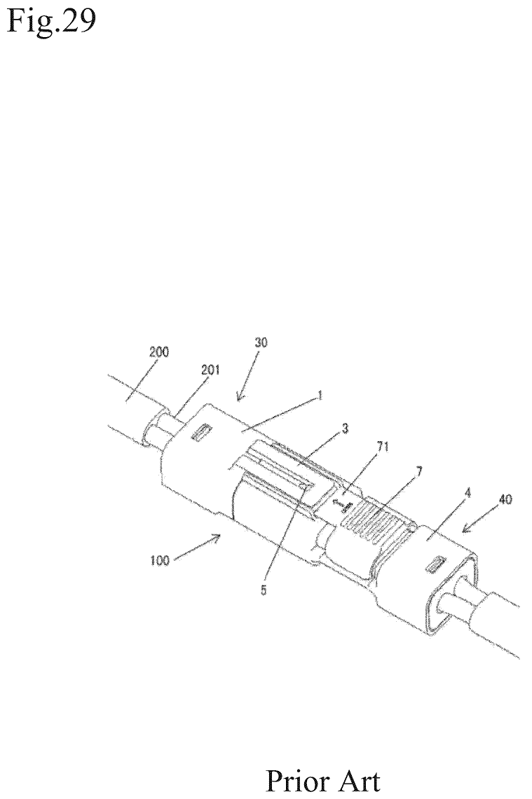

For example, a further modification can be adopted for the second connector 20 described above upon maintaining the configuration that exercises function effects described above. Thus, various modification examples that the second connector of the present invention may take will be described with reference to FIGS. 23 to 27. Note that the other-side connector to be mated with a second connector 40 according to the modification is the same as the first connector 10 of the present embodiment described with reference to FIGS. 1 to 7. A member identical or similar to the second connector 20 of the present embodiment described above is denoted by the same reference numeral, and description thereof will be omitted.

The second connector 40 according to the modification shown in FIGS. 23 to 27 has a plate spring shaped portion 43 as an elastic member that exerts an elastic force at a center position of the unlocking member 23. This plate spring shaped portion 43 is a cantilevered member extending backward (the −X direction) and always maintains a horizontal state so as to be parallel to an upper surface constituting the unlocking member 23.

On the other hand, an inclined shaped portion 41 having an inclined surface shape facing upward and protruding is formed at a center position on a slightly back side of an upper surface of the second connector housing 21.

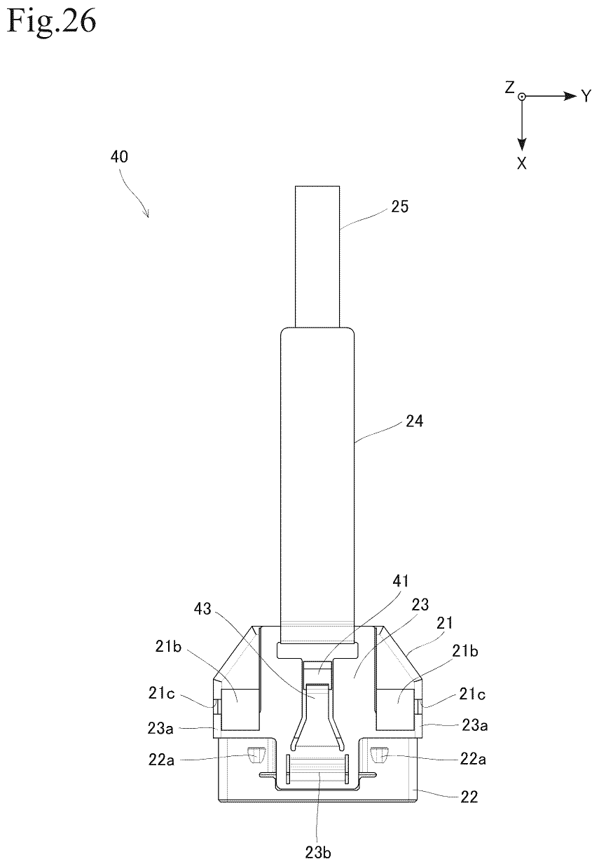

A positional relationship between the plate spring shaped portion 43 and the inclined shaped portion 41 is such that in the case in which the unlocking member 23 of the second connector 40 is positioned on the front side in the movable range as shown in FIGS. 23 and 26, the plate spring shaped portion 43 and the inclined shaped portion 41 do not interfere with each other, and the plate spring shaped portion 43 does not exert an elastic force on the inclined shaped portion 41. However, when the user pulls the operating member 24 backward to perform a moving operation of the unlocking member 23 in the backward direction (the −X direction) to release the locked state of the locking member 14 and the unlocking member 23 as described above, the unlocking member 23 of the second connector 40 moves backward in the movable range. Thus, a free end on the back side of the plate spring shaped portion 43 rides on the inclined shaped portion 41, so that the plate spring shaped portion 43 exerts an elastic force on the inclined shaped portion 41. This elastic force becomes a force of the plate spring shaped portion 43 pushing the unlocking member 23 forward in the movable range so as to return to the original horizontal state. Therefore, when the user pulls the operating member 24 backward to perform a moving operation of the unlocking member 23 in the backward direction (the −X direction) to release the locked state of the locking member 14 and the unlocking member 23 and then releases his/her finger from the operating member 24, the plate spring shaped portion 43 exerts an elastic force for moving the unlocking member 23 forward (the +X direction) to return to the initial position. That is, with the second connector 40 according to the modification, the unlocking member 23 of the second connector 40 released from the locked state and the mated state with the first connector 10 can be automatically returned to the front side position in the movable range which is the initial state.

Moreover, the connector locking mechanism according to the present invention can be variously modified within a range in which function effects similar to those of the embodiment and modification described above can be exercised. For example, in the embodiment and modification described above, the first connector is configured such that the two engagement holes 15 which are the first locking shaped portions of the present invention are arranged on the left and right and the single first unlocking portion 16 is arranged therebetween. In correspondence to this configuration, the second connector is configured such that the two projections 22a which are the second locking shaped portions of the present invention are arranged on the left and right, and the single second unlocking portion 23b is arranged therebetween. However, in the connector locking mechanism according to the present invention, the number of each of the first locking shaped portions and the second locking shaped portions may be one, or may be three or more. Similarly, the number of each of the first unlocking portions and the second unlocking portions may also be two or more. Any arrangement configuration can also be adopted for the arrangement positions of the first locking shaped portions and the second locking shaped portions as well as the first unlocking portion and the second unlocking portion.

It is apparent from the recitation of the scope of claims that embodiments changed or altered in the above manner may also be included in the technical scope of the present invention.

### REFERENCE SIGNS LIST

10 first connector (according to the present embodiment)
11 first mating opening
12 metal shell
13 cutout portion
14 locking member
14a free end
14b fixed end
15 engagement hole (first locking shaped portion)
16 first unlocking portion
20 second connector (according to the present embodiment)
21 second connector housing
21a second mating opening
21b holding shaped portion
21c restricting portion
22 frame member
22a projection (second locking shaped portion)
23 unlocking member
23a arm
23b second unlocking portion
23c attachment hole
24 operating member
24a attachment groove
25 electrical cord
40 second connector (according to the modification)
41 inclined shaped portion
43 plate spring shaped portion (elastic member)
100 connector assembly

What is claimed is:

1. A connector locking mechanism comprising:
a first connector including
a cantilevered locking member extending in a first direction, and having
a first locking shaped portion, and
a first unlocking portion having an inclined surface and formed between a fixed end of the locking member and the first locking shaped portion; and
a second connector mated with the first connector in a second direction opposite to the first direction, and including
an unlocking member held to be movable in the first direction and the second direction,
a second locking shaped portion to be engaged with the first locking shaped portion formed in the locking member, and
a second unlocking portion having an inclined surface to be brought into contact with the inclined surface of the first unlocking portion when the second connector is mated with or withdrawn from the first connector,
wherein the locking member and the unlocking member are located at positions overlapped in a third direction orthogonal to the first direction and the second direction in a locked state in which the first connector and the second connector are locked with each other.

2. The connector locking mechanism according to claim 1, wherein the first unlocking portion and the first locking shaped portion are arranged in parallel in the first direction.

3. The connector locking mechanism according to claim 1, wherein
the locking member is formed by cutting out a part of a metal shell constituting an outer enclosure of the first connector, and
the inclined surface of the first unlocking portion is formed by bending the locking member.

4. The connector locking mechanism according to claim 1, wherein the second connector has a restricting portion that restricts a relative moving range of the unlocking member with respect to the second connector when the unlocking member moves in the first direction to transition to an unlocked state and then abuts on a part of the second connector.

5. The connector locking mechanism according to claim 1, wherein the first unlocking portion of the locking member and the second unlocking portion of the unlocking member respectively have the inclined surfaces to be brought into contact with each other when the unlocking member is moved in the second direction.

6. The connector locking mechanism according to claim 1, further comprising an elastic member that exerts an elastic force for moving the unlocking member to return to an initial position after the unlocking member moves in the first direction to transition to an unlocked state in which the first connector and the second connector are unlocked from each other.

7. A connector assembly comprising:
the connector locking mechanism according to claim 1,
wherein the first connector and the second connector are mated with each other.
